(19) United States
(12) Patent Application Publication
(10) Pub. No.: US 2010/0023564 A1
(43) Pub. Date: Jan. 28, 2010

(54) SYNCHRONOUS REPLICATION FOR FAULT TOLERANCE

(75) Inventors: Ramana Yerneni, Cupertino, CA (US); Jayavel Shanmugasundaram, Santa Clara, CA (US); Fan Yang, Mountain View, CA (US)

Correspondence Address: BERKELEY LAW & TECHNOLOGY GROUP LLP, 17933 NW EVERGREEN PARKWAY, SUITE 250, BEAVERTON, OR, 97006, US

(73) Assignee: Yahoo! Inc., Sunnyvale, CA (US)

(21) Appl. No.: 12/180,364

(22) Filed: Jul. 25, 2008

(51) Int. Cl. G06F 17/30

(52) U.S. Cl. 707/204; 707/E17.007

(57) ABSTRACT

Subject matter disclosed herein relates to data management of multiple applications, and in particular, to fault tolerance for such management.

### BACKGROUND

1. Field

Subject matter disclosed herein relates to data management of multiple applications, and in particular, to fault tolerance for such management.

2. Information

A growing number of organizations or other entities are facing challenges regarding database management. Such management may include fault tolerance, wherein a fault-tolerant system may experience a failure for a portion of its database and still continue to successfully function. However, a fault-tolerant system may include a process of copying or replicating a database in which the database may be “shut down” during such copying or replication. For example, if a particular database is involved in a process of replication while information is being “written” to the database, an accurate replica may not be realized. Hence, it may not be possible to write information during a replication process, even for fault-tolerant systems. Unfortunately, shutting down a database, even for a relatively short period of time, may be inconvenient.

### BRIEF DESCRIPTION OF THE FIGURES

Non-limiting and non-exhaustive embodiments will be described with reference to the following figures, wherein like reference numerals refer to like parts throughout the various figures unless otherwise specified.

FIG. 1 is a schematic diagram of a data-management system, according to an embodiment.

FIG. 2 is a schematic diagram of a database cluster, according to an embodiment.

FIG. 3 is a schematic diagram of a database cluster in the presence of a computing node failure, according to an embodiment.

FIG. 4 is a schematic diagram of a database cluster involving load balancing, according to an embodiment.

FIG. 5 illustrates a procedure that may be performed by a recovery controller, according to an embodiment.

FIG. 6 illustrates a procedure that may be performed by a connection controller, according to an embodiment.

FIG. 7 illustrates a procedure that may be performed to create database replicas, according to an embodiment.

### DETAILED DESCRIPTION

Some portions of the detailed description which follow are presented in terms of algorithms and/or symbolic representations of operations on data bits or binary digital signals stored within a computing system memory, such as a computer memory. These algorithmic descriptions and/or representations are the techniques used by those of ordinary skill in the data processing arts to convey the substance of their work to others skilled in the art. An algorithm is here, and generally, considered to be a self-consistent sequence of operations and/or similar processing leading to a desired result. The operations and/or processing involve physical manipulations of physical quantities. Typically, although not necessarily, these quantities may take the form of electrical and/or magnetic signals capable of being stored, transferred, combined, compared and/or otherwise manipulated. It has proven convenient at times, principally for reasons of common usage, to refer to these signals as bits, data, values, elements, symbols, characters, terms, numbers, numerals and/or the like. It should be understood, however, that all of these and similar terms are to be associated with the appropriate physical quantities and are merely convenient labels. Unless specifically stated otherwise, as apparent from the following discussion, it is appreciated that throughout this specification discussions utilizing terms such as “processing”, “computing”, “calculating”, “associating”, “identifying”, “determining” and/or the like refer to the actions and/or processes of a computing node, such as a computer or a similar electronic computing device, that manipulates and/or transforms data represented as physical electronic and/or magnetic quantities within the computing node's memories, registers, and/or other information storage, transmission, and/or display devices.

Reference throughout this specification to “one embodiment” or “an embodiment” means that a particular feature, structure, or characteristic described in connection with the embodiment is included in at least one embodiment of claimed subject matter. Thus, the appearances of the phrase “in one embodiment” or “an embodiment” in various places throughout this specification are not necessarily all referring to the same embodiment. Furthermore, the particular features, structures, or characteristics may be combined in one or more embodiments.

In an embodiment of a data-management system, one or more replicas of a database may be maintained across multiple computing nodes in a cluster. Such maintenance may involve migrating one or more databases from one computer node to another in order to maintain load balancing or to avoid a system bottleneck, for example. Migrating a database may include a process of copying the database. Such maintenance may also involve creating a database replica upon failure of a computing node. In a particular implementation, creating a new database replica or copying a database for load balancing may involve a process that allows a relatively high level of access to a database while it is being copied. Such a process may include segmenting a database into one or more tables and copying the one or more tables one at a time to one of the multiple computing nodes. Such a process may be designed to reduce downtime of a database since only a relatively small portion of a database is typically copied during any given time period. The remaining portion of such a database may therefore remain accessible for reading or writing, for example. Further, even the small portion involved in copying may be accessed for reading, even if not accessible to writing. Copying by such a process may also create one or more replicas of a new database introduced to the data-management system. Copying may be synchronous in that states of particular defined databases among the originals and replicas are the same at points in time. For example, if a state of a replica database is to be modified or created, the state of a replica database may be held static (e.g., not be modified or created) until such a modification or creation is confirmed at an original database to ensure consistency among these databases.

In a particular embodiment, a data-management system may include one or more database clusters. Individual database clusters may include multiple database computing nodes. In one implementation, a database cluster includes ten or more database computing nodes, for example. Such multiple database computing nodes may be managed by a fault-tolerant controller, which may provide fault tolerance against computing node failure, manage service level agreements (SLA) for databases among the computing nodes, and/or provide load balancing of such databases among the computing nodes of the database cluster, just to list a few examples. Database computing nodes may include commercially available hardware and may be capable of running commercially available database management system (DBMS) applications. In a particular embodiment, system architecture of a data-management system may include a single-node DBMS as a building block. In such a single-node DBMS, a computing node may host one or more databases and/or process queries issued by a controller, for example, without communication with another computing node, as explained below.

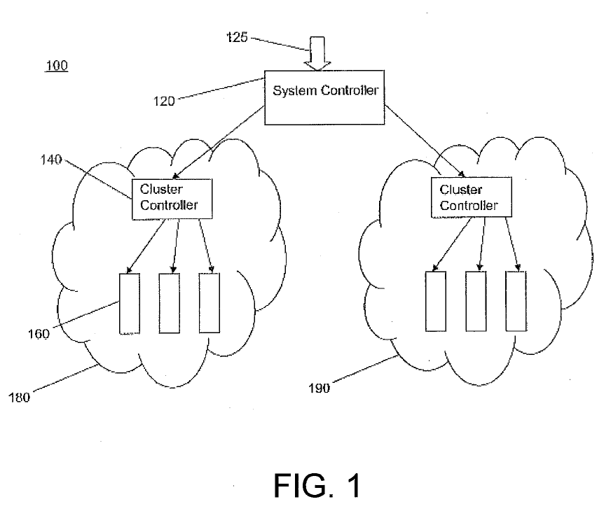

FIG. 1 is a schematic diagram of a data-management system 100, according to an embodiment. Such a data-management system may provide an API to allow a client to develop, maintain, and execute applications via the Internet, for example. A system controller 120 may receive information such as applications, instructions, and/or data from one or more clients (not shown), as represented by arrow 125 in FIG. 1. System controller 120 may route such information to one or more clusters 180 and 190. Such clusters may include a cluster controller 140 to manage one or more database (DB) computing nodes 160. Although DB computing nodes within a cluster may be co-located, clusters may be located in different geographical locations to reduce risk of data lost due to disaster events, as explained below. For example, cluster 180 may be located in one building or region and cluster 190 may be located in another building or region.

In one implementation, in determining how to route client information to clusters, system controller 120 may consider, among other things, locations of clusters and risks of data loss. In another implementation, system controller 120 may route read/write requests associated with a particular database to the cluster that hosts the database. In yet another implementation, system controller 120 may manage a pool of available computing nodes and add computing nodes to clusters based, at least in part, on what resources may be needed to satisfy client demands, for example.

In an embodiment, cluster controller 140 may comprise a fault-tolerant controller, which may provide fault tolerance against computing node failure while managing DB computing nodes 160. Cluster controller 140 may also manage SLA's for databases among the computing nodes, and/or provide load balancing of such databases among the computing nodes of the database cluster, for example. In one implementation, DB computing nodes 160 may be interconnected via high-speed Ethernet, possibly within the same computing node rack, for example.

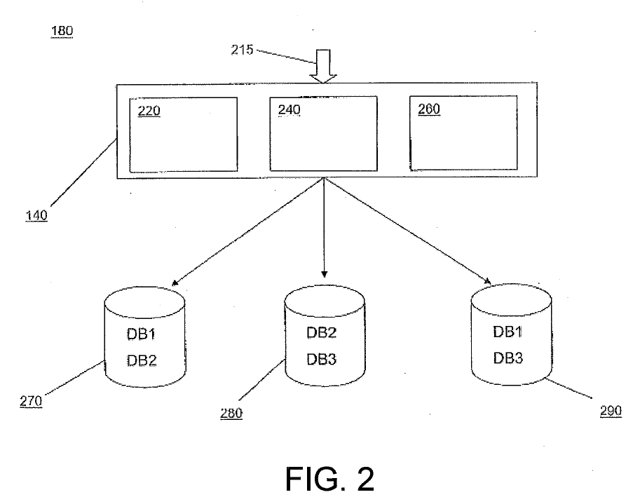

FIG. 2 is a schematic diagram of a database cluster, such as cluster 180 shown in FIG. 1, according to an embodiment. Such a database cluster may include a cluster controller, such as cluster controller 140 shown in FIG. 1. Cluster controller 140 may manage DB computing nodes, such as DB computing node 160 shown in FIG. 1, which may include one or more databases 270, 280, and 290, for example. Cluster controller 140 may include a connection controller 220, a recovery controller 240, and a placement controller 260, for example. In one implementation, multiple replicas for individual databases may be maintained across multiple DB computing nodes 160 within a cluster to provide fault tolerance against a computing node failure. Replicas may be generated using synchronous replication, as described below. In one implementation, DB computing nodes may operate independently without interacting with other DB computing nodes. Individual DB computing nodes may receive requests from connection controller 220 to behave as a participant of a distributed transaction. An individual database may be hosted on a single DB computing node, which may host multiple databases simultaneously.

Connection controller 220 may maintain mapping information associating databases with their associated replica locations. Connection controller 220 may issue a write request, such as during a client transaction, against all replicas of a particular database while a read request may only be answered by one of the replicas. Such a process may be called a read-one-write-all strategy. Accordingly, an individual client transaction may be mapped into a distributed transaction. In one implementation, transactional semantics may be provided to clients using a two-phase commit (2PC) protocol for distributed transactions. In this manner, connection controller 220 may act as a transaction coordinator while individual computing nodes act as resource managers. Of course, such a protocol is only an example, and claimed subject matter is not so limited.

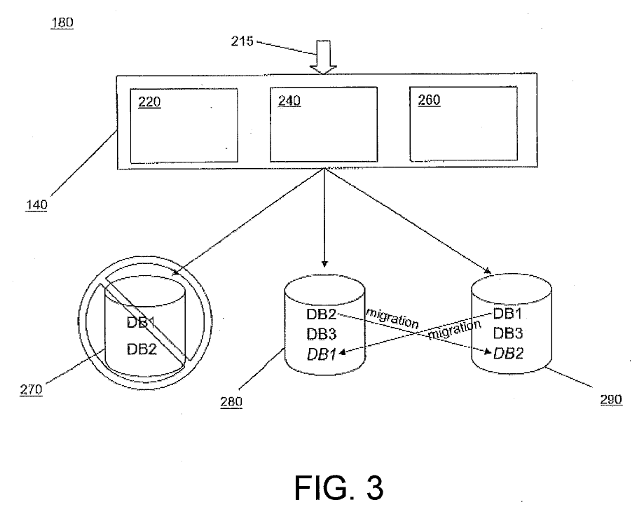

FIG. 3 is a schematic diagram of a database cluster in the presence of a computing node failure, according to an embodiment. If a computing node fails, a client request associated with a particular database may be served using a remaining replica of the database. In response to this computing node failure, a data-management system may operate in a sub-fault-tolerant mode since further computing node failure may cause loss of data, for example. Accordingly, it may be desirable to recover the system to fault-tolerance state by providing a process of restoring replicas for each database to compensate for the replicas lost due to the computing node failure. In one embodiment, such a process may be automated and managed by recovery controller 240. For example, recovery controller 240 may monitor DB computing nodes 160 to check for a failure. A detected failure may initiate a process carried out by the recovery controller to create new replicas of the failed DB computing node. In the example shown in FIG. 3, a failure of a DB computing node has rendered database 270, which includes databases DB1 and DB2, unusable. Databases DB 1 and DB2 also exist in databases 290 and 280, respectively, but the failure associated with database 270 has left an inadequate number of replicas remaining in the system to provide further fault-tolerance. To reestablish the system back to a fault-tolerant mode, recovery controller 240 may create new replicas DB1 and DB2 in databases 280 and 290, respectively. In one particular implementation, new replicas may be created by copying from remaining replicas. Recovery controller 240 may create the new replicas across multiple DB computing nodes by segmenting a remaining database replica into one or more tables and copying the tables one at a time to the multiple DB computing nodes. During such a recovery, client requests may be directed to surviving replicas of affected databases that may be currently executing.

In an embodiment, a fault-tolerant data-management system may maintain multiple replicas for one or more databases to provide protection from data loss during computing node failure, as discussed above. For example, after a computing node fails, the system may still serve client requests using remaining replicas of the databases. However, the system may no longer be fault-tolerant since another computing node failure may result in data loss. Therefore, in a particular implementation, the system may restore itself to a full fault-tolerant state by creating new replicas to replace those lost in the failed computing node. In one particular implementation, the system may carry out a process wherein new replicas may be created by copying from remaining replicas, as mentioned above. During such a process, a database in the failed computing node may be in one of three consecutive states: 1) Before copying, the database may be in a weak fault-tolerant state and new failures may result in data loss. 2) During copying, the database may be copied over to a computing node from a remaining replica to create a new replica. During copying, updates to the database may be rejected to avoid errors and inconsistencies among the replicas. 3) After copying, the database is restored to a fault-tolerant state.

Within a cluster, a recovery controller may monitor the status of computing nodes using heartbeat messages. For example, such a message may include a short message sent periodically from the computing nodes to the recovery controller. If the recovery controller does not receive an expected heartbeat message from any computing node, it may investigate to find the status of that node, for example. In a particular embodiment, if a recovery controller determines that a node is no longer operational, the recovery controller may initiate a recovery of the failed node. Also, upon detecting such a failure, the recovery controller may notify a connection controller to divert client requests away from the failed computing node. The connection controller may also use remaining database replicas to continue serving the client requests.

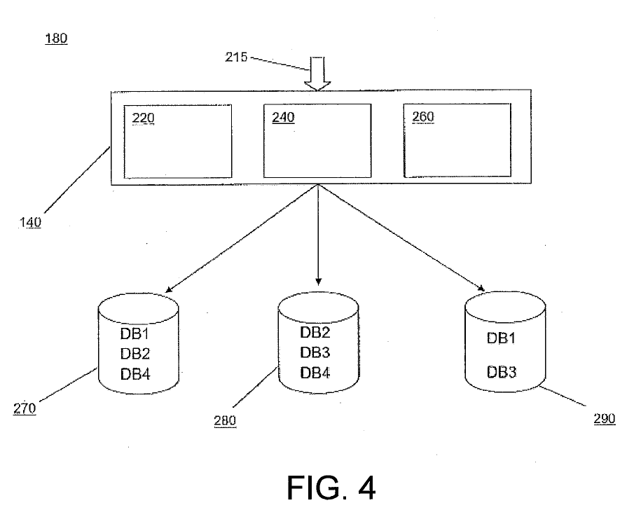

FIG. 4 is a schematic diagram of a database cluster involving load balancing, according to an embodiment. Placement controller 260 may determine how to group databases among DB computing nodes. For example, a new client may introduce a new associated database, which may be located by a determination of placement controller 260. Such a determination may consider avoiding violating any SLA's associated with databases while minimizing the number of DB computing nodes used, as explained below. Placement controller 260 may also create one or more replicas of the new database across multiple DB computing nodes by segmenting the new database into one or more relatively small tables and copying the tables one at a time to the multiple DB computing nodes.

As mentioned above, one embodiment includes a system that provides fault tolerance by maintaining multiple replicas for individual databases. Accordingly, client transactions may be translated into distributed transactions to update all database replicas using a read-one-write-all protocol. For such a distributed transaction, a connection controller and DB computing nodes may function as transaction manager and resource managers, respectively.

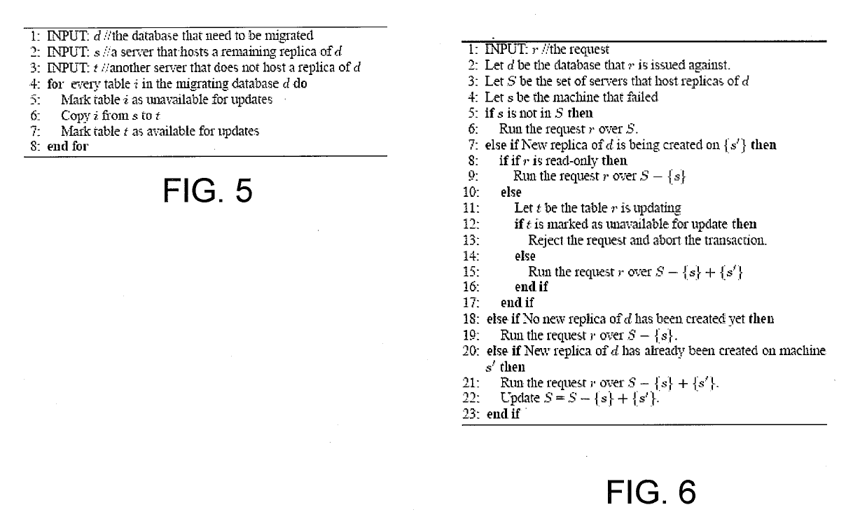

As mentioned above, in response to a failure of a computing node, a database may be used to create new replicas. In such a failed state, updates to the database, such as non read-only transactions, may be rejected to avoid errors and inconsistencies among replicas. Rejecting such transactions may render a database unavailable for updates for an extended period, depending on the size of the database to replicate. In an embodiment, such an extended period of unavailability may be reduced by segmenting a database into one or more tables and copying the tables one at a time. Such a process may allow copying of a database during which only a small portion of the database is unavailable for a relatively short period at any given time. A connection controller and a recovery controller, such as those shown in FIG. 2, may cooperate with one another to allow consistency among replicas of databases. FIG. 5 shows a procedure that may be performed by the recovery controller and FIG. 6 shows a procedure that may be performed by the connection controller, according to an embodiment. In the case of a structured query language (SQL) interface, for example, a new replica may be consistent with an original because such a language interface may not allow updating more than one table in one query. The procedures shown in FIGS. 5 and 6 may allow a transaction to be consistently applied among replicas that are represented as multiple tables, even if some tables have been updated while others have yet to be updated, as long as an update is not attempted on a currently migrating table. Accordingly, table-by-table copying may result in a reduced number of rejected transactions.

As mentioned earlier, a fault-tolerant controller may manage service level agreements (SLA) for databases among computing nodes in a cluster, according to an embodiment. An SLA may include two specifications, both of which may be specified in terms of a particular query/update transactional workload: 1) a minimum throughput over a time period, wherein throughput may be the number of transactions per unit time; and 2) a maximum percentage of proactively rejected transactions per unit time. Proactively rejected transactions may comprise transactions that are rejected due to computing node failures, for example, database replication, and other operations that are specific to implementing a data management node, and not inherent to running an application. In an embodiment, the number of proactively rejected transactions may be kept below a specified threshold. In an implementation, a procedure for limiting such rejections may include determining what resources may be needed to support an SLA for a particular database using a designated standalone computing node to host the database during a trial period. During the trial period, throughput and workload for the database may be collected over a period of time. The collected throughput and workload may then be used as a throughput SLA for the database. System resources adequate for a given SLA may be determined by considering the central processing unit (CPU), memory, and disk input/output (I/O) of the system, for example. CPU usage and disk I/O may be measured using commercially available monitoring tools such as MySQL, for example. However, real memory consumption for a database may not be directly measurable: DBMS, which may be used as a system building block, as mentioned above, may use a pre-allocated memory buffer pool for query processing, which may be determined upon computing node start-up and may not be dynamically changed. Knowing what system resources are available for a given SLA may involve a determination of memory consumption. Accordingly, a procedure to measure memory consumption, according to an embodiment, may determine whether a buffer pool is smaller than the size of a working set of accessed data. If so, then a system may experience thrashing, wherein disk I/O may be greatly increased. Thus, there may be a minimum buffer pool that does not result in thrashing. Such a minimum buffer pool may be used as a memory requirement for sustaining and SLA for a particular database.

In an embodiment, computing nodes may be allocated to host multiple replicas of a newly introduced database. For each database replica, selection of a computing node may be based on whether the computing node may host the replica without violating constraints of an SLA for the database. In a particular implementation, each replica may be allocated a different computing node.

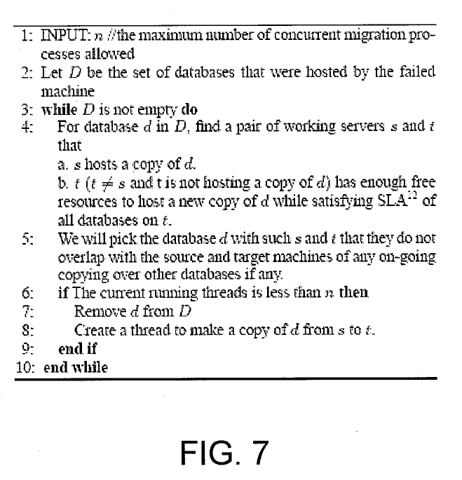

As discussed above, if a computing node fails, a recovery controller, such as recovery controller 240 shown in FIG. 2, may copy each database that was hosted on the failed computing node. Such a procedure may consider SLA's associated with each database to provide conditions and resources to accommodate the SLA's. FIG. 7 shows a procedure that may be performed by a recovery controller to create replicas, according to an embodiment. For every database d hosted by a failed computing node, the recovery controller may find a pair of source and target computing nodes s, t such that a replica may be hosted on s and t with enough available resources to host a new replica of d while satisfying an SLA throughput requirement for all databases hosted on t. Then a new process may be created to replicate d from s to t. To achieve benefits of parallelization, databases may be chosen so that source and target computing nodes do not overlap with an on-going copying process. A limit on the number of concurrent copying processes may be imposed to avoid overloading and thrashing the system. In a particular embodiment, if there are not enough resources to host new replicas, such as a full hard disk, a cluster controller, such as cluster controller 140 shown in FIG. 1, may allocate more computing nodes to its cluster without interrupting the system. Of course, there are a number of ways to create replicas, and claimed subject matter is not limited in this respect to illustrated embodiments.

While there has been illustrated and described what are presently considered to be example embodiments, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular embodiments disclosed, but that such claimed subject matter may also include all embodiments falling within the scope of the appended claims, and equivalents thereof.

What is claimed is:

1. A method comprising:
maintaining one or more synchronous replicas of a database across multiple computing nodes in a cluster; and
creating new replicas upon failure of a computing node among said multiple computing nodes.

2. The method of claim 1, wherein creating new replicas comprises:
segmenting said database into one or more tables; and
copying said one or more tables one at a time to one of said multiple computing nodes.

3. The method of claim 1, further comprising:
creating one or more replicas of a new database upon introduction of said new database; and
associating said one or more replicas of said new database with said multiple computing nodes.

4. The method of claim 3, wherein creating one or more replicas comprises:
segmenting said new database into one or more tables; and
copying said one or more tables one at a time to one of said multiple computing nodes.

5. The method of claim 1, further comprising reading said database while creating said new replicas.

6. The method of claim 1, further comprising writing a portion of said database while creating said new replicas.

7. The method of claim 3, wherein said associating is based, at least in part, upon a service level agreement (SLA) associated with the new database.

8. The method of claim 1, further comprising repeating creating said new replicas while said computing node is in a sub-fault tolerant mode.

9. A device comprising:
a connection controller to maintain one or more synchronous replicas of a database across multiple computing nodes in a cluster; and
a recovery controller to create new replicas upon failure of a computing node among said multiple computing nodes.

10. The device of claim 9, further comprising a placement controller to associate said one or more replicas with said multiple computing nodes.

11. The device of claim 9, wherein the recovery controller is capable of reducing said database to one or more tables for copying said tables one at a time across said multiple computing nodes.

12. The device of claim 10, wherein the placement controller is capable of reducing a new database to one or more tables for copying said tables one at a time across said multiple computing nodes.

13. The device of claim 9, wherein said database is readable while said recovery controller creates new replicas.

14. The device of claim 9, wherein said database is writeable.

15. The device of claim 10, wherein said placement controller associates said one or more replicas with said multiple computing nodes based, at least in part, upon a service level agreement (SLA).

16. An article comprising a storage medium comprising machine-readable instructions stored thereon which, if executed by a computing node, are adapted to enable said computing node to:
maintain one or more synchronous replicas of a database across multiple computing nodes in a cluster; and
create new replicas upon failure of a computing node among said multiple computing nodes.

17. The article of claim 16, wherein creating new replicas comprises:
segmenting said database into one or more tables; and
copying said one or more tables one at a time to one of said multiple computing nodes.

18. The article of claim 16, wherein said machine-readable instructions, if executed by said computing node, are further adapted to enable said computing node to:
create one or more replicas of a new database upon introduction of said new database; and
associate said one or more replicas of said new database with said multiple computing nodes.

19. The article of claim 18, wherein creating one or more replicas comprises:
segmenting said new database into one or more tables; and
copying said one or more tables one at a time to one of said multiple computing nodes.

20. The article of claim 18, wherein said associating is based, at least in part, upon a service level agreement (SLA) associated with the new database.

21. The article of claim 16, wherein said machine-readable instructions, if executed by said computing node, are further adapted to enable said computing node to:
read said database while creating said new replicas.

22. The article of claim 16, wherein said machine-readable instructions, if executed by said computing node, are further adapted to enable said computing node to:
write a portion of said database while creating said new replicas.

23. The article of claim 16, wherein said machine-readable instructions, if executed by said computing node, are further adapted to enable said computing node to:
repeat creating said new replicas while said multiple computing nodes are in a sub-fault tolerant mode.

24. A method comprising:
migrating a copy of a database across multiple computing nodes in a cluster to maintain load balancing, said migrating comprising:
segmenting said database copy into one or more tables; and
copying said one or more tables one at a time to one of said multiple computing nodes.

25. The method of claim 24, wherein said database is readable during said migrating.

26. The method of claim 25, wherein said database, except for a portion of said database that includes said table that is being copied, is writeable during said migrating.
